(19) United States
(12) Patent Application Publication
(10) Pub. No.: US 2015/0219579 A1
(43) Pub. Date: Aug. 6, 2015

(54) METHOD FOR DETECTING AUTOANTIBODIES

(71) Applicant: ISIS INNOVATION LIMITED, Oxford (GB)

(72) Inventor: Jason Davis, Oxford (GB)

(21) Appl. No.: 14/414,678

(22) PCT Filed: Jul. 12, 2013
(86) PCT No.: PCT/GB2013/051862

§ 371 Date: Jan. 13, 2015

(30) Foreign Application Priority Data
Jul. 13, 2012 (GB) 1212528.2

(51) Int. Cl. G01N 27/22; G01N 27/327

(52) U.S. Cl. CPC G01N 27/22; G01N 27/327

(57) ABSTRACT

A method for the detection of autoantibodies comprises detecting autoantibodies in a sample from an individual using label free electrochemical impedance spectroscopy. In one aspect, the method is a method for the diagnosis or monitoring of Parkinson's disease comprising detecting α-synuclein autoantibodies in a sample from an individual using electrochemical impedance spectroscopy. We also describe electrodes for use in these methods.

The present invention relates to a method for detecting autoantibodies, and in particular to detect antibodies to α-synuclein for the diagnosis or monitoring of Parkinson's disease, and an electrode for use in such methods.

### BACKGROUND

Parkinson's disease, which causes significant disability and loss of quality of life, is the second most common neurodegenerative disorder in the world. Diagnosis of Parkinson's disease, especially in the early stage, is of great importance. However, early diagnosis can be challenging, as the signs and symptoms overlap with other syndromes.

α-synuclein is a small protein comprised of 140 amino acids with a mass of 14.4 kDa, and it is predominantly expressed in neural tissue. It plays an essential role in synaptic transmission and synaptic plasticity by augmenting transmitter release from the presynaptic terminal. The dysfunctional regulation in α-synuclein, its misfolding, aggregation and fibrillation into Lewy bodies are viewed as key factors in the pathogenesis of Parkinson's disease.

Electrochemical assays have attracted much attention in recent years due to their advantages such as high sensitivity, easy miniaturisation and ability to operate in turbid solutions. Electrochemical immunoassays based on the surface immobilisation of antibodies or nucleic acid aptamers have been applied to the detection of a variety of biomarkers. However, typically, sandwich or labelled assays are conducted. Although highly selective and sensitive, additional processing steps are required. With a growing requirement for fast and facile point of care diagnosis, improved biomarker detection systems are required. Such detection systems would be of particular value in patient screening and earlier diagnosis.

Electrochemical impedance spectroscopy (EIS) is a technique that is capable of sensitively monitoring the changes in capacitance or charge-transfer resistance or some related electrochemical function associated with the specific binding of certain materials to a suitably modified electrode surface.

### SUMMARY OF THE INVENTION

The present inventors have now found an assay system for detecting antibodies, and in particular α-synuclein antibodies that is robust, sensitive and quantative. In particular, the present inventors have found that electrochemical impedance spectroscopy can be used to assay for antibodies in biological samples. The assays can be conducted in the absence of an additional label or amplification technique. The assays can be conducted using undiluted blood serum, and are operable with as little as 5 microlitres of undiluted blood serum. The sensory interfaces are readily prepared, exhibit good selectivity, and are reuseable, without an apparent loss of sensitivity. Furthermore, when applied to the autoantibody screening of Parkinson's disease patient samples, the assays distinguish between early stage patients and controls, and moreover, can be used to track disease progression.

In accordance with the present invention, there is provided a method for the detection of autoantibodies comprising detecting autoantibodies in a sample from an individual using label free electrochemical impedance spectroscopy.

In one aspect, the invention provides a method according to the invention, wherein the method comprises contacting an electrode having α-synuclein or an antibody binding fragment thereof attached to the surface thereof, with a sample, and detecting an electrical signal associated with binding of α-synuclein antibody to the anti-synuclein or an antibody fragment binding fragment thereof.

In another aspect, the invention provides an electrode for use in electrochemical impedance spectroscopy which an electrode comprises:

(a) a substrate having a planar surface; and

(b) α-synuclein or an antibody binding fragment thereof disposed on the planar surface.

### BRIEF DESCRIPTION OF THE FIGURES

FIG. 1—Construction and sensing of the biosensor interface. (a) PEG-Thiol monolayer with a carboxyl end group was formed on bare gold electrode; (b) Attachment of α-synuclein onto the monolayer with the assistance of EDC and NETS; (c) Specific binding of α-synuclein antibody the to immobilized α-synuclein; (d) The R_{CT} of different electrodes.

FIG. 2—Recorded charge-transfer resistance (RCT) of the synuclein interfaces after incubation with controlled concentrations of α-synuclein antibody in PBST (10 mM, pH 7.4) containing 1.0 mM Fe(CN)₆^{3-/4-}. Inset shows the corresponding calibration curve.

FIG. 3—Interference of bovine serum albumin on the biosensor in 10 mM PBST (10 mM, pH 7.4) containing 1.0 mM Fe(CN)₆^{3-/4-}. The horizontal line shows the specific response to 1 nM α-synuclein antibody.

FIG. 4—Synuclein sensor surface regeneration. Electrode interfaces were regenerated by using a flow cell (1 mL volume with a flow rate of 3 mL/min) with 0.5 M glycine/HCl for 10 min and then washed with PBST, and the impedance measurements were taken in a solution containing PBST (10 mM, pH 7.4) and 1.0 mM Fe(CN)₆^{3-/4-}.

FIG. 5—Box and Whisker plot showing the impedance response at α-synuclein interfaces across 23 of PD patients and 14 controls. The large boxes denote the inter-quartile range, with the middle line being the median. The small boxes denote average and “whiskers” denote the minimum and maximums. Concentrations are determined according to the calibration curve previously done in PBST.

FIG. 6—Box and Whisker plot summarising the correlation between assay response and PD disease status across 30 patients and 14 controls.

### DETAILED DESCRIPTION

Optional and preferred features of the present invention are now described. Any of the features described herein may be combined with any of the other features described herein, unless otherwise stated.

The present invention is directed to methods for the diagnosis and/or monitoring of Parkinson's disease. In accordance with the present invention, electrochemical impedance spectroscopy is used to detect for the presence of α-synuclein antibodies in a test sample. The assays take place typically by contacting a sample with an electrode having bound thereto α-synuclein and conducting electro analytical assays to determine changes in impedance associated with binding of α-synuclein antibody to the electrode.

In another aspect, the present application is directed to the use of electrochemical impedance spectroscopy for the analysis of other autoantibodies, and in particular, those associated with disease conditions in an individual. Autoantibodies as defined herein relates to antibodies generated in an individual against self antigens, such as self proteins.

In accordance with a preferred aspect of the present invention, the assays are “label-free”, and in particular, do not require the introduction of a label, for example, to bind to the auto-antibody which binds to the probe molecule on the electrode. For example, secondary labelling of bound antibodies is not required, for example, through the use of secondary antibodies, enzyme amplification or other labels such as gold nanoparticles.

For the detection of autoantibodies, an electrode is provided comprising probe molecules. The probe molecules bind the autoantibodies, and typically, will be the protein or polypeptide to which the autoantibody binds.

In more detail, the inventors have identified that the present methods, which do not require the presence of a label nevertheless exhibit a sufficient degree of sensitivity that low levels of antibodies can be detected, even when present in complex fluids such as biological fluid samples such as blood and blood serum, even when such samples are provided in undiluted form. In particular, the assays in accordance with the present invention are able to detect antibodies when present at a concentration of 0.1 pM to 100 nM, preferably at a concentration of 5 pM to 10 nM. Thus, the methods of the present invention are particularly useful in detecting autoantibodies, that is antibodies generated in an individual against their own or self proteins.

Examples of autoantibodies include anti-thyroid antibodies that may be present in Grave's disease and Hashimoto's thyroiditis, antinuclear antibodies in autoimmune disease, anti-double stranded DNA in systemic lupus erythematosus, antibodies directed against ribonuclear proteins, associated with Sjogren's syndrome, anti-topoisomerase antibodies associated with systemic sclerosis, anti-sp100 antibodies associated with primary biliary cirrhosis, anti-tissue transglutaminase antibodies associated with coeliac disease. For the detection of such autoantibodies, the probe molecule bound to the electrode is the relevant protein or fragment thereof.

The electrode of the present invention comprises probe molecules disposed on the planar surface of a substrate. The probe molecules are capable of binding selectively to a target species. In electrodes for use in the EIS detection of anti-α-synuclein antibodies, the probe molecule is α-synuclein or an antibody binding fragment thereof. In certain electrodes of the present invention, the target species may be another autoantibody, and the probe molecule is a protein or polypeptide recognised by the antibody.

The substrate of the electrode may comprise any electrically conducting material. The substrate may comprise a metal or carbon. The metal may be a metal in elemental form or an alloy of a metal. Optionally, the whole of the substrate comprises a metal or carbon. The substrate may comprise a transition metal. The substrate may comprise a transition metal selected from any of groups 9 to 11 of the Periodic Table. The substrate may comprise a metal selected from, but not limited to, rhenium, iridium, palladium, platinum, copper, indium, rubidium, silver and gold. The substrate may comprise a metal selected from gold, silver and platinum. The substrate may comprise a carbon-containing material, which may be selected from edge plane pyrolytic graphite, basal plane pyrolytic graphite, glassy carbon, boron doped diamond, highly ordered pyrolytic graphite, carbon powder and carbon nanotubes.

In a preferred embodiment, the substrate comprises gold, for example the substrate is a gold substrate.

The surface of the substrate is planar, which includes a generally flat surface, typically without indentations, protrusions and pores. Such substrate surfaces can be readily prepared, before probe molecules and any associated linker molecules are bound to the surface, by techniques such as polishing with fine particles, e.g. spraying with fine particles, optionally in a sequence of steps where the size of the fine particles is decreased in each polishing step. The fine particles may, for example, comprise a carbon-based material, such as diamond, and/or may have particles with diameters of 10 μm or less, optionally 5 μm or less, optionally 3 μm or less, optionally 1 μm or less, optionally 0.5 μm or less, optionally 0.1 μm or less. Following polishing, the substrate surface may be washed, e.g. ultrasonically, optionally in a suitable liquid medium, such as water, e.g. for a period of at least 1 minute, e.g. from about 1 minute to 10 minutes. Optionally, the substrate surface may be washed with an abrasive, e.g. acidic, solution, for example following the polishing and, if used, ultrasonic washing steps. The abrasive solution may comprise an inorganic acid, e.g. H₂SO₄, and/or a peroxide, e.g. H₂O₂, in a suitable liquid medium, e.g. water. Optionally, the substrates can be electrochemically polished, which may follow any steps involving one or more of polishing with fine particles, washing e.g. ultrasonically and/or using an abrasive solution. The electrochemical polishing may involve cycling between an upper and lower potential until a stable reduction peak is reached, e.g. an upper potential of 0.5 V or more, optionally 1 V or more, optionally 1.25 V or more, and a lower potential of 0.5 V or less, optionally 0.25 V or less, optionally 0.1 V or less.

The probe molecule preferably comprises or is a binding species selected from a peptide or a protein. The peptide or protein is the peptide or protein recognised by the autoantibody. For example, the probe molecule may be α-synuclein or an antibody binding fragment thereof, where the antibody binding fragment thereof binds to autoantibodies produced in an individual suffering from Parkinson's disease.

The electrode may be provided as a microelectrode array, comprising more than 1 working electrode with a shared counter electrode. Such an array may include 4, 5, 6 up to 10 or 20 or more electrodes with one or more selected electrode. Each working electrode may be modified to bind to the same or different autoantibodies. The microarray may be set up to allow separate samples to be incubated with each working electrode, or more than one working electrode.

The probe molecule may be directly attached to the surface of the substrate or attached to the surface of the substrate via a linker species. If a linker species is present on the surface of the substrate, the linker species may for example comprise a self-assembling monolayer or may comprise a self-assembling monolayer-anchored polymer.

The electrode as described herein may be formed by forming a self-assembling monolayer of linker species, optionally activating the linker species, and then binding the probe molecule to at least some of the linker species. The electrode as described herein may also be formed by forming a self-assembling monolayer, forming a polymer linker species on the self-assembling monolayer (i.e, to obtain a self-assembling monolayer-anchored polymer), optionally activating the polymer linker species, and then binding the binding species to at least some of the linker species.

Preferably, the substrate surface having the probe molecules thereon, as a whole, is selective for the target species, for example for the autoantibody to be detected, such as α-synuclein antibodies. If the substrate surface having the probe molecules thereon is selective for the target species, this indicates that substantially only or only the target species will bind to the surface via binding to the probe molecules, and other species, for example present in the sample with the target species, will not bind, or not bind to any significant degree, to other parts of the substrate surface or other species thereon. Such selective substrate surfaces may be termed highly selective substrate surfaces or highly selective electrode surfaces.

In an embodiment, the probe molecule is of the formula A-L-B, wherein A is a moiety bound to the planar surface of the substrate, L is a linker moiety and B is a moiety capable of binding selectively to α-synuclein antibodies.

‘A’ may be selected from any appropriate binding group, depending on the nature of the material of the substrate. For example, A may be selected from, but is not limited to, biotin, hydrazine, alkynyl, alkylazide, amino, hydroxyl, carboxy, thio, aldehyde, phosphoinothioester, maleimidyl, succinyl, succinimidyl, isocyanate, ester, strepavidin, avidin, neuavidin, and biotin binding proteins. If the substrate comprises a noble material, e.g. gold, silver or platinum, A is preferably thiol (or thiolate), which may be selected from —SH and —S—. If the substrate comprises a metal that has a layer of oxide on its surface, e.g. copper, A may be a carboxy group.

L may be any species that covalently links A to B. L is preferably a species that allows formation of a self-assembling monolayer. For example, L may be a hydrocarbon moiety. L may comprise an alkylene moiety comprising at least 2 carbons, the alkylene moiety being directly attached to A; optionally the alkylene moiety is a straight-chain alkylene moiety. L may comprise an alkylene moiety comprising at least 10 carbons, optionally from 10 to 30 carbons, optionally from 10 to 20 carbons, optionally from 11 to 15 carbon atoms, and the alkylene moiety is optionally a straight-chain alkylene moiety, and the alkylene moiety is directly attached to A.

For the avoidance of doubt, “alkylene” as used throughout this specification means an alkyl group having at least two (for example two) hydrogen atoms removed therefrom, e.g. it means for example alkanediyl. The terms “alkylene” and “alkyl” may be used interchangeably because it is clear from context how many hydrogen atoms of the corresponding (parent) alkane must be removed in order for the group to be attached to other specified functional groups. For example, the group L must be capable of attaching at least to A and to B, thereby meaning that at least two (e.g., two) carbon atoms have been removed from the corresponding alkane.

In an embodiment, L is of the formula —(CH₂)ₙ—(—O—CH₂—CH₂—)ₘ-D-, wherein n is from 1 to 30 and m is from 0 to 10 and D is a bond or a group bound to B. D may for example be selected from a bond or —(C═O)—, —OCH₂—(C═O)—, —(C═O)—NH—, —(C═O)—O—, —OCH₂—(C═O)—NH—, —OCH₂—(C═O)—OH—, —O— or —NH—. n may for example be from 10 to 20. m may for example be 1 to 5, optionally 2 to 4, optionally 3. Optionally, if D is any one of the species (C═O)—NH—, —(C═O)—O—, —OCH₂—(C═O)—NH—, —OCH₂—(C═O)—O—, —O— and —NH—, then —NH— or —O— in these species may be derived from a probe molecule, e.g. a protein or peptide which binds an autoantibody, prior to being bound to the linker species L.

B may be selected from a binding species as described above, for example, selected from a peptide or a protein that specifically binds to the target autoantibody. In a preferred aspect, B is α-synuclein or a fragment thereof, and typically is full length α-synuclein.

In an embodiment, A-L- is a species of formula thiol-(CH₂)ₙ—(—O—CH₂—CH₂—)ₘ-D-wherein n is from 1 to 30 and m is from 0 to 10 and D is a group that binds to B; optionally n, m and D may be as defined above, and thiol is selected from —S— and HS—.

Thus, in a preferred embodiment, the electrode is coated with polyethylene glycol (PEG) thiol, which is then activated for binding to the probe molecule.

In an embodiment, an electrode as described herein, e.g. having probe molecules thereon, may be produced by providing the substrate having the planar surface, then forming a self-assembling monolayer of linker species on the planar surface, and attaching probe moieties, e.g. proteins, to at least some of the linker species. The linker species may optionally be activated, e.g. by reaction with an activator, such as N-hydroxysuccinimide (NHS), or NHS and 1-ethyl-3-(3-dimethylaminopropyl) carbodiimide (EDC) to allow for facile attachment of the probe moieties to the linker species. In an embodiment, the linker species forming the self-assembling monolayer are of the formula A-L, wherein A is a moiety that binds to the surface of the substrate and L is a linker moiety capable of binding to a moiety (which may be denoted B) which binds to the target species, e.g. a protein or peptide to which the autoantibody binds.

In an embodiment, the probe molecules may comprise a polymer that is attached both to: (a) the planar surface of the substrate; and (b) to a moiety B capable of binding selectively to the autoantibody under investigation. Preferably said polymer comprises a plurality of pendant betaine groups. A betaine group is a group that comprises both a positively charged cationic functional group that bears no hydrogen atom (e.g., a quaternary ammonium or phosphonium functional group) and a negatively charged functional group (for example a carboxylate group or a sulfonate group). Pendant means that the said betaine groups are side groups extending away from the main chain of the polymer (i.e., the chain derived from repeating monomeric units).

The pendant betaine groups may, for example, each comprise a quaternary ammonium cation and a carboxylate group. For example, the pendant betaine groups may have the formula (I)

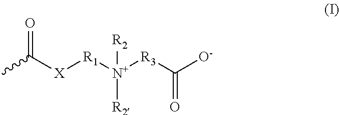

wherein:
R₁ and R₃ are the same or different and are each a C₁ to C₅ alkylene group;
R₂ and R_{2′} are the same or different and are each a C₁ to C₅ alkyl group; and

### X is O or NH.

In one exemplary aspect the pendant betaine groups may have the formula (I) wherein R₁ and R₃ are ethylene, R₂ and R_{2′} are methyl and X is O. A polymer containing such pendant groups can be obtained by photopolymerisation of carboxybetaine (alkyl)acrylates such as carboxybetaine methylacrylate (CBMA) and carboxybetaine ethylacrylate (CBEA). In another exemplary aspect the pendant betaine groups may have the formula (I) wherein R₁ is propylene, R₃ is ethylene, R₂ and R_{2′} are methyl and X is NH. A polymer containing such pendant groups can be obtained by photopolymerisation of carboxybetaine (alkyl)acrylamides such as carboxybetaine acrylamide.

The polymer may for example have a hydrocarbon main chain, for example a main chain that is a straight chain or branched chain alkylene moiety (e.g., having at least 10 carbon atoms, optionally at least 50 carbon atoms, optionally at least 100 carbon atoms). Typically where the polymer comprises a plurality of pendant betaine groups the polymer comprises at least 5, or at least 10, for example at least 25 pendant betaine groups. Such polymers are for example obtainable by photopolymerisation of photopolymerisable monomers containing a photopolymerisable carbon-carbon double bond (as well as a betaine group, should the polymer comprise a plurality of pendant betaine groups). For example, monomers comprising (alkyl)acrylate groups such as acrylate, methacrylate and ethyacrylate can be used.

In one preferred aspect of the present invention, the electrodes are obtainable by carrying out the method of making an electrode of the present invention, as described in more detail herein.

In accordance with one aspect of the present invention, the electrode is provided for the detection of α-synuclein autoantibodies. α-synuclein has the sequence

(SEQ ID NO: 1)
MDVFMKGLSKAKEGVVAAAEKTKQGVAEAAGKTKEGVLYVGSKTKEGVVH
GVATVAEKTKEQVTNVGGAVVTGVTAVAQKTVEGAGSIAAATGFVKKDQL
GKNEEGAPQEGILEDMPVDPDNEAYEMPSEEGYQDYEPEA.

α-synuclein may also be provided in the form of a mutant version, such as a mutant version that occurs in Parkinson's disease, for example, having a mutation A53T, A30P or E46K. Preferably, the α-synuclein as used in accordance with the present invention as the sequence set out above, optionally containing 1, 2, 3, 4, 5 up to 10 mutations in the sequence, and which retains the ability to bind to antibodies produced in an individual to α-synuclein. Fragments of the protein may also be used, for example, fragments containing the full length α-synuclein, optionally having 1, 2, 3, 4, 5 up to 10 amino acids truncated from the C-terminal, N-terminal or both the C- and N-terminals. Smaller fragments can also be used, for example, of 30, 40, 50, 60, 70, 80 or up to 100 amino acids in length, so long as such fragments bind to antibodies generated in an individual against α-synuclein.

For the detection of other autoantibodies associated with different disease conditions in an individual, the probe molecule comprises the protein or a fragment thereof to which the antibody binds, or in the case of antibodies directed against double stranded DNA, such double stranded DNA.

The present application also relates to a method for detecting autoantibodies, such as α-synuclein antibodies in an electrochemical impedance spectroscopy technique, wherein the method comprises: (a) contacting an electrode of the present invention with a sample containing or suspected of containing autoantibodies, such as α-synuclein antibodies; and (b) detecting an electrical signal at the working electrode.

Electrochemical impedance spectroscopy (EIS) is known to the skilled person. Generally, a varying ac potential is applied on a bias (or DC) potential between a working electrode and a counter electrode. Generally, EIS involves scanning across a range of ac frequencies. The ratio of the input signal (typically the varying potential) to the output signal (typically the varying current) allows the impedance to be calculated. There is generally a phase difference between the input signal and the output signal, such that the impedance can be considered as a complex function, having a real part (sometimes termed Z′) and an imaginary part (sometimes termed Z″).

The real and imaginary parts of impedance can be plotted against one another, e.g. in the form of a Nyquist plot. By fitting the impedance data to an assumed equivalent circuit, the electron transfer resistance can be determined, which is one means through which the binding event can be assessed.

The frequency range of the varying ac potential applied may be from 0.05 Hz to 10 kHz. The amplitude of the applied ac potential, which is typically in the form of a sine wave, may be from 1 mV to 100 mV, optionally from 5 mV to 50 mV, optionally from 5 mV to 20 mV, optionally from 5 mV to 15 mV, optionally 8 mV to 12 mV, optionally about 10 mV. The bias potential (or direct current potential) may be set at any desired potential. If a redox probe is present in the carrier medium, the bias potential may be set at the electrode potential of the redox probe under the conditions at which the method is carried out.

In one aspect, a redox probe may be present in the carrier medium, and the method may involve Faradaic EIS. If a redox probe is present, it may be a transition metal species, wherein the transition metal can adopt two valence states (e.g. a metal ion (M) being able to adopt M(II) and M(III) states). In an embodiment, the redox probe contains a metal ion, wherein the metal of the metal ion is selected from iron, ruthenium, iridium, osmium, cobalt, tungsten and molybdenum. In an embodiment, the redox probe is selected from Fe(CN)₆^{3-/4-}, Fe(NH₃)₆^{3+/2+}, Fe(phen)₃^{3+/2+}, Fe(bipy)₂^{3+/2+}, Fe(bipy)₃^{3+/2+}, Ru^{3+/2+}, RuO₄^{3-/2-}, Ru(CN)₆^{3-/4-}, Ru(NH₃)₆^{3+/2+}, Ru(en)₃^{3+/2+}, Ru(NH₃)₅(Py)^{3+/2+}, Ir^{4+/3+}, Ir(Cl)₆^{2-/3-}, Os(bipy)₂^{3+/2+}, Os(bipy)₃^{3+/2+}, OxCl₆^{2-/3-}, Co(NH₃)₆^{3+/2+}, W(CN)₆^{3-/4-}, Mo(CN)₆^{3-/4-}, optionally substituted ferrocene, polyferrocene, quiniones, such as p-benzoquinone and hydroquinone and phenol In an embodiment, the redox probe is an iron-containing species in which iron is in Fe(II) and/or Fe(III) states. In an embodiment, the redox probe is Fe(CN)₆^{3-/4-}. The redox probe may be present in the carrier medium an amount of from 0.1 mM to 100 mM, optionally from 0.5 mM to 10 mM, optionally from 0.5 mM to 2 mM, optionally from 0.5 mM to 1.5 mM, optionally about 1 mM.

In another aspect, the EIS technique is a non-Faradaic EIS technique. In this aspect, no redox probe is added to the carrier medium. For example, the carrier medium may contain no externally added, i.e., exogenous, redox probe, for example it may comprise no redox probe.

The sample is typically a biological fluid. A biological fluid may be a fluid that has been obtained from a subject, which may be a human or an animal, and is typically a human. In an embodiment, the sample comprises an undiluted biological fluid. An undiluted biological fluid in the present context is a biological fluid obtained from a subject, e.g. a human or animal, that has not been diluted with another liquid, although additives such as a redox probe, may be present in the undiluted biological fluid. The biological fluid may be selected from blood, urine, tears, saliva, sweat, and cerebrospinal fluid, and is typically a blood serum sample.

Optionally, the sample comprises a biological fluid obtained from a subject, e.g. a human or animal, and a diluent. The diluent may be added to the biological fluid after it has been obtained from the subject. The diluent may include a liquid medium, e.g. a liquid medium selected from water and an alcohol, e.g. an alcohol, e.g. ethanol. The carrier medium may further comprise a buffer. The buffer may comprise a phosphate.

Thus, in accordance with one aspect of the invention, the method comprises providing a sample from a patient, such as a blood serum sample. The electrode coated with probe molecules may be contacted directly with the sample such as the blood serum sample, and incubated for a period of time to allow antibody binding. Typically, the sample is incubated with the electrode for a period of time of at least 1 minute, such as 5 minutes, 10 minutes, 20 minutes, 30 minutes, up to 1 hour, 2 hours, 4 hours, 8 hours or more. Typically, the incubation is conducted at room temperature, for example, between 18° C. to 25° C. Typically 1 to 500 such as 5 to 100 μl or up to 200 μl of sample are incubated with the electrode.

The electrodes may be rinsed prior to EIS assessment. Redox probe is typically added to the sample, or the rinsed electrode is placed in buffer containing the redox probe for EIS assessment.

The method may comprise calculating the concentration of the target species (e.g., α-synuclein antibodies) from the electrical signal. The electrical signal may be converted into impedance data and then converted to the concentration of the target species (e.g., α-synuclein antibodies) from the electrical signal. The electrical signal may be converted into charge transfer resistance data, or phase change data, and then converted to the concentration of the target species (e.g., α-synuclein antibodies) from the electrical signal. The method may involve comparing the data obtained in the electrochemical impedance spectroscopy technique, e.g. from the electrical signal, the impedance data, the charge transfer resistance data, or the phase change data, and comparing the data with data obtained in a calibration step, to obtain the concentration of the target species (e.g., α-synuclein antibodies). The method may involve an initial calibration step that determines a relationship between the concentration of the target species (e.g., α-synuclein antibodies) and electrochemical data obtained from the electrochemical signal in the electrochemical impedance spectroscopy technique; the electrochemical data may be selected from impedance data, charge transfer resistance data and phase change data or any derived mathematical function; the relationship may be used to convert the electrochemical data obtained from a sample of interest in the electrochemical impedance spectroscopy technique to the concentration of the target species (e.g., α-synuclein antibodies) in the sample.

The concentration of the target species, for example the autoantibody to be detected, such as α-synuclein antibodies in the carrier medium may be 0.1 pM or more, optionally 0.2 pM or more, optionally 0.5 pM or more, optionally 1.0 pM or more. The concentration of the target species (e.g., α-synuclein antibodies) in the carrier medium may be 100 nM or less, optionally 80 nM or less, optionally 50 nM or less, optionally 10 nM or less. The concentration of the target species (e.g., α-synuclein antibodies) in the carrier medium may be from 0.1 pM to 100 nM, optionally from 0.2 pM to 100 nM, optionally from 0.5 pM to 50 nM. Preferably the autoantibodies, such as α-synuclein are present at a concentration of 5 pM to 10 nM.

In accordance with the present invention, the method may be used as a marker for Parkinson's disease. The method may involve comparing the concentration of α-synuclein antibodies to the concentration from a normal sample. An increase in the levels of α-synuclein antibodies, for example, such as concentrations over 0.4 nM, for example, 0.6 nM scores the patient as suffering from Parkinson's disease. Alternatively, the levels of α-synuclein antibodies can be compared to a normal sample, an individual not suffering the symptoms of Parkinson's disease, in which the levels of antibody are 2, 3 or 4 fold higher than those of the controlled samples.

The levels of α-synuclein antibodies can also be used to monitor the progress of Parkinson's disease, with higher levels or increases in the levels of autoantibodies being associated with progression from stage 1 to stage 2 and stage 2.5 Parkinson's disease. In accordance with this aspect of the present invention, typically, samples are taken from the same patient over a period of time to monitor the progression of their Parkinson's disease. For example, the method may be conducted on samples taken from the individual at intervals of 1 month, 2 months, 3 months, 6 months, 1 year, 18 months, 2 years or 3 years or more. Alternatively, the levels are compared to normal controls, or to samples from other individuals known to be suffering from Parkinson's disease to correlate the level of antibodies with the stage of Parkinson's disease.

The present inventors have found that it is possible to regenerate the electrode that has been bound to target species (e.g., α-synuclein antibodies), by dissociating bound target species (e.g., α-synuclein antibodies) from the electrode. The method may therefore involve, after contacting the electrode with the carrier medium such that target species (e.g., α-synuclein antibodies) is bound to the probe molecules, dissociating target species (e.g., α-synuclein antibodies) from the probe molecules. The dissociating may comprise contacting of the electrode surface having target species (e.g. α-synuclein antibodies) thereon with an acidic liquid medium, optionally having a pH of 6 or lower, optionally a pH of 5 or lower, for example a pH of 4 or lower. The acidic liquid medium may contain an acidic substance, for example an acidic buffer (for example, glycine hydrochloride). The acidic liquid medium may be aqueous or non-aqueous. For example, it may be a non-aqueous medium comprising a non-aqueous solvent such as DMSO.

The method may further comprise, after dissociating α-synuclein antibodies from the probe molecules, reusing the electrode in one or more further methods for detecting α-synuclein antibodies in an electrochemical impedance spectroscopy technique. Each such further method may comprise carrying out a method for detecting α-synuclein antibodies of the present invention.

An electrode for use in an electrochemical impedance spectroscopy technique, in accordance with the present invention may be made by a method which comprises:

(a) attaching photopolymerisable monomers to the planar surface of a substrate, thereby obtaining a modified surface having a layer of polymerisable monomers disposed thereon; then

(b) contacting said modified surface with further photopolymerisable monomers, and optionally crosslinking monomers, and photochemically polymerising the monomers, thereby generating an electrode comprising polymers disposed on said planar surface.

This method leads to a polymer-modified substrate surface which is substantially non-fouling. Furthermore, the method steps can be carried out in aqueous solution and by photoinitiation under moderate and safe laboratory conditions.

The photopolymerisable monomers may be attached to the planar surface of a substrate in step (a) by methods known in the art, for example using the methods described herein for attaching a linker moiety ‘L’ to a substrate surface. It will be appreciated that depending on the chemical nature of both the substrate and the monomers, it may be possible to attach the monomers to the surface directly. Alternatively, the surface may first be chemically activated to introduce chemically reactive functional groups (such as, but not limited to, thiol or amine groups), which enable attachment of the monomers. For example, cysteamine is commonly used to introduce reactive amine functional groups onto gold substrates; the thiol group on the cysteamine reagent binds to the substrate and the resulting free amine groups can readily be reacted with a suitable functional groups, such as a carboxylic acid group, on the monomers (in the case of a carboxylic acid group on the monomers, resulting in formation of an amide bond). Typically the step of attaching the photopolymerisable monomers comprises covalently or semi-covalently attaching photopolymerisable monomers to the planar surface of the substrate (i.e., formation of a covalent or semi-covalent bond between the photopolymerisable monomers and the substrate surface). For the avoidance of doubt, attaching photopolymerisable monomers to the planar surface of a gold substrate via a gold-sulfur bond is included within the scope of the term “covalently or semi-covalently attaching” (the gold-sulfur bond being regarded as a covalent or semi-covalent bond, e.g. a semi-covalent bond).

The modified surface having a layer of photopolymerisable monomers disposed thereon may be a self-assembled monolayer.

In the method of the invention, step (a) is carried out before step (b). Thus, step (a) is carried out, then step (b) is carried out. This means that (typically covalent) attachment of a layer of photopolymerisable monomers is substantially complete before the modified surface is contacted with further photopolymerisable monomers, optionally crosslinking monomers, and the photochemical polymerisation is carried out. This multi-step nature of the method leads to the generation of a stable and homogenously modified substrate surface.

Typically, but not essentially, the photopolymerisable monomers used in steps (a) and (b) are the same.

Preferably the photopolymerisable monomers (and further photopolymerisable monomers) are photopolymerisable betaine monomers. However, other photopolymerisable monomers may be used. For example other photopolymerisable monomers capable of forming hydrogel polymers or other zwitterionic photopolymerisable monomers may be used.

The photopolymerisable betaine monomers comprise a photopolymerisable functional group and a betaine group. As explained in the foregoing disclosure, a betaine group is a group that comprises both a positively charged cationic functional group which bears no hydrogen atom (e.g., a quaternary ammonium or phosphonium functional group) and a negatively charged functional group (for example a carboxylate group or a sulfonate group).

The photopolymerisable group may be any group susceptible to photopolymerisation under conditions suitable for electrode surface modification. In an embodiment, the photopolymerisable monomers may each comprise a photopolymerisable carbon-carbon double bond. For example, the photopolymerisable monomers may comprise (alkyl)acrylate groups, such as acrylate, methacrylate and/or ethyacrylate groups. In the case of a photopolymerisable betaine monomer, the photopolymerisable group is a group other than the positively charged cationic functional group of the betaine group and the negatively charged functional group of the betaine group.

In an embodiment, the polymerisable betaine monomers each comprise a quaternary ammonium cation and a carboxylate group. The photopolymerisable betaine monomers may, for example, be of the formula (II)

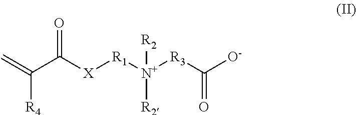

wherein:
R₁ and R₃ are the same or different and are each a C₁ to C₅ alkylene group;
R₂ and R_{2′} are the same or different and are each a C₁ to C₅ alkyl group;
R₄ is a hydrogen atom or a C₁ to C₅ alkyl group; and

### X is O or NH.

In exemplary aspects of the method, the photopolymerisable betaine monomers are selected from carboxybetaine methacrylate (CBMA), carboxybetaine acrylamine (CBAA) and carboxybetaine ethylacrylate (CBEA).

Crosslinking monomers may optionally be used in the step (b). One suitable crosslinker is ethyleneglycol dimethacrylate (EGDMA), although other crosslinkers known in the art can also be used.

A photoinitiator is typically used to initiate the photochemical polymerisation of the monomers in the step (b). Any suitable photoinitator can be used of the many photoinitiators known in the art. Non-limiting examples of suitable photoinitiators include methylbenzoyl formate and 1-hydroxycyclohexyphenyl ketone.

The photopolymerisation may result in polymers that comprise a plurality of pendant betaine groups, as described elsewhere herein. The polymers may for example comprise at least 5, or at least 10, for example at least 25 pendant betaine groups.

The photopolymerisation may result in a polymer that may for example have a hydrocarbon main chain, for example a main chain that is a straight chain or branched chain alkylene moiety (e.g., having at least 10 carbon atoms, optionally at least 50 carbon atoms, optionally at least 100 carbon atoms).

In a preferred aspect, this method further comprises (c) attaching probe molecules capable of specific binding to a target species to said polymers. The probe molecules may be attached directly to the polymers provided both the probe molecules and polymers have suitable accessible reactive functional groups. Alternatively, the polymers, or the probe molecules, may be chemically activated by reacting them with suitable activating compounds known in the art. For example, accessible negatively charged functional groups such as carboxylate groups on pendant betaine groups of the polymer may readily be activated using compounds such as NHS, thereby rendering them chemically reactive to probe molecules such as proteins or peptides which recognise autoantibodies of interest as discussed in more detail herein.

The present invention also relates to an electrochemical impedance spectrometer, wherein the spectrometer comprises an electrode as defined herein. The electrochemical impedance spectrometer may be of a standard design. The electrochemical impedance spectrometer may comprise an electrode of the present invention as a working electrode, a counter electrode, and, if desired a reference electrode. The electrochemical impedance spectrometer preferably comprises a means for applying, controlling and varying a potential between the working and counter electrodes, and a means for measuring the resultant current. The electrochemical impedance spectrometer preferably comprises a potentiostat for controlling the potential and measuring the resultant current. The electrochemical impedance spectrometer preferably comprises a means for calculating impedance data from the potential applied and the resultant current. The electrochemical impedance spectrometer may comprise a means for calculating electron transfer resistance of the working electrode.

The electrochemical impedance spectrometer is preferably for detecting autoantibodies such as α-synuclein antibodies present in a carrier medium at a concentration of 0.1 pM or more, optionally 0.2 pM or more, optionally 0.5 pM or more, optionally 1.0 pM or more.

The present invention also relates to the use of an electrode as described herein, or an electrochemical impedance spectrometer as described herein, for the detection of a target species, e.g. autoantibodies such as α-synuclein antibodies. The use may include detecting the presence of and/or detecting the concentration of the target species, e.g. α-synuclein antibodies. The use may be for detecting autoantibodies such as α-synuclein antibodies present in a carrier medium at a concentration of 0.1 pM or more, optionally 0.2 pM or more, optionally 0.5 pM or more, optionally 1.0 pM or more.

### Examples

### Materials and Apparatus

The anti-human α-synuclein was purchased from Santa Cruz Biotechnology, Inc. Bovine serum albumin (BSA) was purchased from Sigma Aldrich. Recombinant human α-synuclein was expressed in E coli and purified as described previously (Gruden et al, Journal of Neuroimmunology, 2011, 233, 221-227). 1-ethyl-3-(3-dimethylaminopropyl) carbodiimide (EDC) and N-hydroxysuccinimde (NHS) were purchased from Sigma Aldrich. Polyethylene glycol (PEG) thiol HS—C₁₁-(EG)₃-OCH₂—COOH was purchased from Prochimia Surfaces, Poland. Ultrapure water (18.2 MΩ/cm) was obtained from a Milli-Q system and used throughout. Phosphate buffered saline (PBS, 10 mM) with Tween-20 (PBST, 10 mM, pH 7.4) was prepared by dissolving PBS tablets (Sigma Aldrich) in water with 0.2% v/v Tween-20 added, and filtered using a 0.22 μm membrane filter. All other chemicals were of analytical grade.

Electrochemical experiments were performed with an Autolab Potentiostat 12 equipped with an FRA2 module (Metrohm Autolab B.V.). A conventional three-electrode system with a gold disk working electrode (1.6 mm diameter, BASi), platinum wire counter electrode and a silver/silver chloride (Ag/AgCl, filled with 1.0 M KCl) reference electrode (CH Instruments) were used. All potentials are reported relative to this reference.

### Human Subjects

30 PD patients (20 males and 10 females) with a mean (SD) age of 64.4 (10.1) years were recruited from the outpatient clinic of the Department of Neurology at Umea University Hospital. -Patients have been neurologically examined at the Department on several occasions and diagnosed as having clinically definite PD according to the UK Parkinson's Disease Society Brain Bank clinical diagnostic criteria (Fahn & Elton, The UPDRS Development Committee. Unified Parkinson's disease rating scale. In: S. Fahn, C. D. Marsden, D. Calne, M. Goldstein, eds., Recent developments in Parkinson's disease. Florham Park, N.J.: Macmillan Healthcare Information, 1987, 153-163). Severity was assessed by the Hoehn and Yahr score (Hoehn & Yahr, Neurology, 1967, 17, 427-& and Goetz et al, Movement Disorders, 2004, 19, 1020-1028). In 43% (13/30) of the patients the function of presynaptic dopamine system was investigated by FP-CIT SPECT imaging. All 13 patients showed reduced uptake of ligand in the putamen, as expected in PD and other forms of idiopathicparkinsonism. Patients with concomitant neurological or psychiatric diseases, cancer and other severe diseases were excluded. 14 healthy controls, 12 males and 2 females with a mean (SD) age of 64.2 (8.7) years, biologically unrelated to the patients, were selected from spouses and friends of patients attending the outpatient clinic. The exclusion criteria for controls were identical to that of patients.

All participants gave their written informed consent after receiving information on the details of the study according to the Helsinki declaration. The ethics committee of Umea University approved the study.

### Surface Modification

Gold disk electrodes were firstly polished with 3.0, 1.0 and 0.1 μm diamond spray (Kemet International Ltd) in sequence and ultrasonically washed in water for about 5 min prior to immersion in freshly prepared piranha solution (concentrated H₂SO₄:H₂O₂, v/v 3:1. Caution: this must be handled with extreme care!) for 15 min. Electrodes were then electrochemically polished by potential cycling between −0.1 and 1.25 V until a stable reduction peak was obtained. The effective surface area of the gold electrode can be calculated at this point (Hoogvliet et al, Analytical Chemistry, 2000, 72, 2016-2021).

Pre-treated gold electrodes were then dried in a flow of nitrogen gas and immediately immersed in a 10 mM solution of HS—C₁₁-(EG)₃-OCH₂—COOH in ethanol for 16 hours at room temperature for self-assembly. The biocompatible and antifouling properties of such PEG containing films enable specific assessments to be made in complex biological fluid. After the formation of self-assembled monolayer, gold surfaces were rinsed with ethanol then water and dried in a flow of nitrogen gas prior to incubation in a solution containing 0.4 M EDC and 0.1 M NHS for 15 minutes (terminal carboxyl group activation) and then 10 μM α-synuclein solution (0.1 M acetate buffer, pH 4) for 1 hour (Scheme 1). To ensure all of the NHS groups had reacted, the electrodes were finally immersed in 1 M Ethanolamine (pH8.5) for 10 minutes.

### Electrochemical Impedance Spectroscopy

Electrochemical impedance spectroscopy (EIS) spectra were recorded in the frequency range from 0.05 Hz to 10 kHz. The amplitude of the applied sine wave potential was 10 mV with the direct current potential set at 0.25 V (the E₀ of the redox probe used, 1.0 mM Fe(CN)₆^{3-/4-}). Data was acquired in 10 mM PBST solution, plotted in the form of complex plane diagrams (Nyquist plots), and fitted through an ideal Randles equivalent circuit (Vyas et al, Journal of Physical Chemistry B, 2010, 114, 15818-15824).

For the assay of pure α-synuclein antibody, modified electrodes were incubated in α-synuclein antibody spiked PBST (10 mM, pH 7.4) containing 1.0 mM Fe(CN)₆^{3-/4-} at room temperature for 30 min, and EIS responses were recorded in the same incubation solution. To initially evaluate interfacial selectivity BSA was used and measured similarly. For the assay of PD patient blood serum samples or controls, biosensors were incubated in the real patient samples or controls at room temperature for 30 min, and then rinsed with PBST prior to EIS assessment in PBST containing 1.0 mM Fe(CN)₆^{3-/4-}.

Used biosensors were regenerated using a flow cell (1 mL volume with a flow rate of 3 mL/min) with 0.5 M glycine/HCl for 10 min prior to PBST washing.

### Results and Discussion

Prior to testing patient samples, synuclein interfaces were generated and their recruitment of antibody from buffered aqueous solution (PBST) characterised.

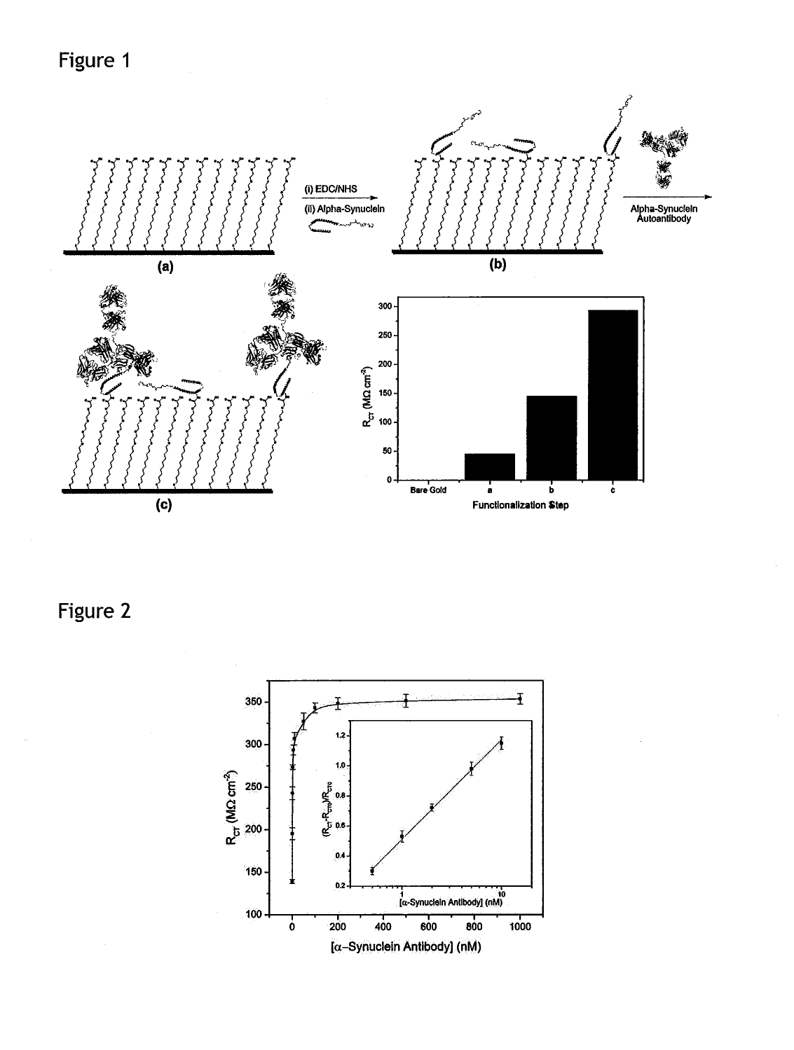

Electrochemical impedance spectroscopy (EIS) presents a useful means of characterising the stepwise fabrication of a biosensory interface where quantified interfacial impedance directly reflects the steric and/or electrostatic barriers presented to a solution phase redox probe as it encounters an electrode surface. Predictably, there are sharp increases in charge-transfer resistance (R_{CT}) on forming the pegylated self-assembled monolayer (55 kΩ/cm² to 40-50 MΩ/cm²) and then again on α-synuclein protein immobilisation (139±2 MΩ/cm²) (FIG. 1).

The resistance of the fabricated interface thereafter responds sensitively to target antibody binding and was initially calibrated against α-synuclein antibody spiked in PBST (0.5 nM to 100 nM in a PBST solution containing 1.0 mM Fe(CN)₆^{3-/4}). The Faradaic impedance of the immobilized α-synuclein interface was measured and the data fitted with the Randles equivalent circuit (Vyas et al). This exercise can be applied both to the determination of an interfacial binding constant and the generation of a linear analytical curve (FIG. 2). At antibody levels in excess of 100 nM, the interfacial coverage is saturating with no further increases in resistance. The interfacial dissociation constant K_{D} is calculated here to be 1.7±0.1 nM, by fitting the data to a Langmuir equation (Huang et al, Analytical Chemistry, 2008, 80, 9157-9161), with R²=0.985. Prior to saturation, the interfacial resistance reports linearly with logarithmic sensitivity on α-synuclein antibody concentration across a 0.5-10 nM range (equivalent to 75 ng/mL to 1.5 μg/mL) with a limit of detection (LOD) of 55±3 pM (equating to ˜8.2 ng/mL).

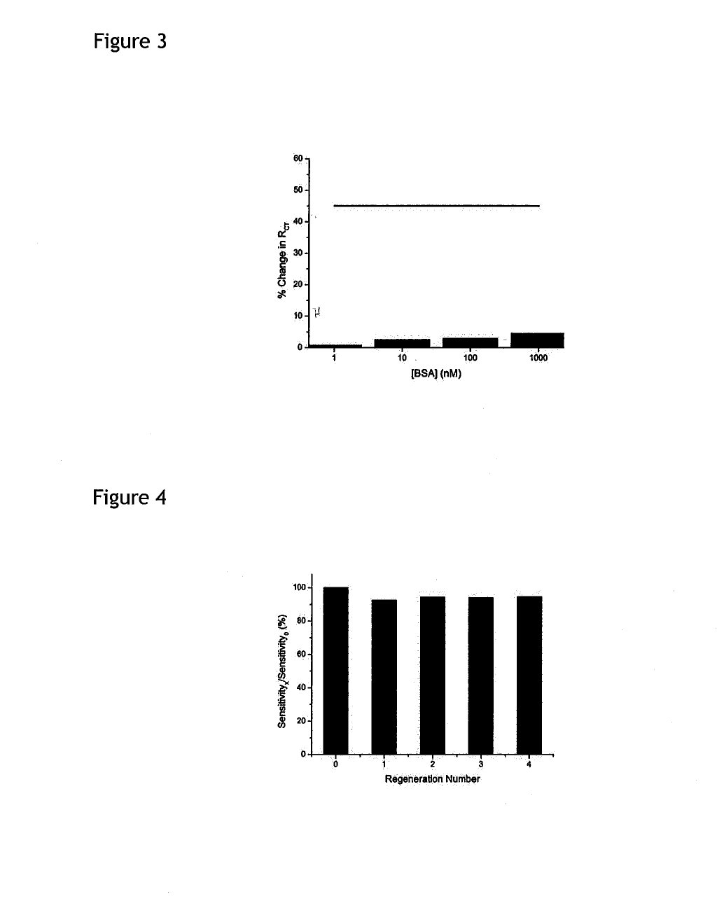

The selectiveness of the α-synuclein interface was analysed by incubation with bovine serum albumin (BSA), a commonly used plasma protein standard. Even at a concentration of 1000 nM, 3 orders of magnitude greater than the synuclein autoantibody levels being sampled, the interfacial impedance of these electrodes remained largely unresponsive (about 5% change in R_{CT}, FIG. 3).

After assaying, these interfaces could be reliably regenerated by surface washing in a flow cell with 0.5 M Glycine/HCl for 10 min to disassociate the α-synuclein antibody-antigen complex, prior to subsequent reuse with negligible (less than 5%) decline in sensitivity (FIG. 4).

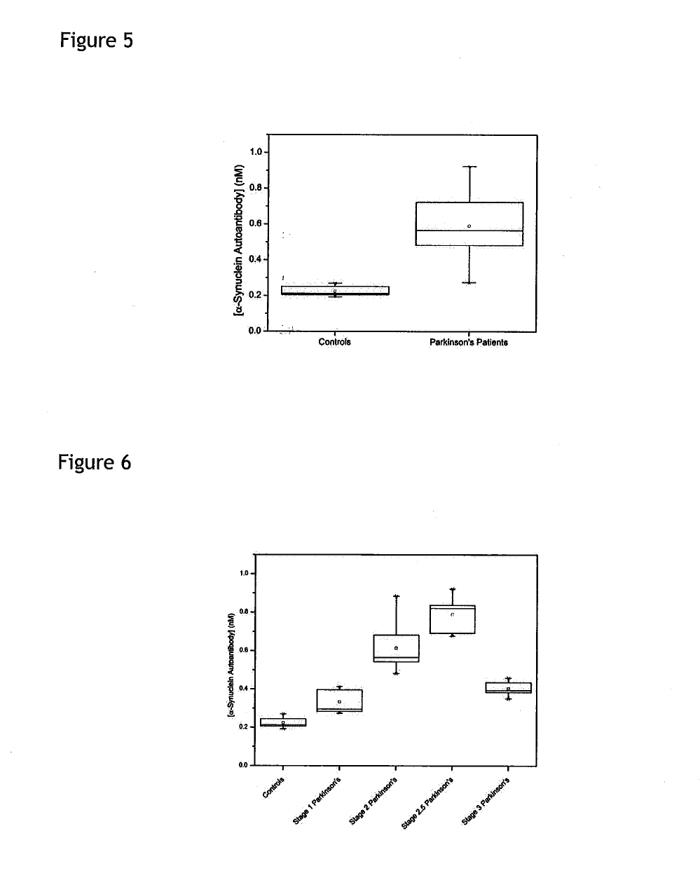

From a point-of-care perspective, the direct and facile assessment of disease biomarkers in low volume levels of undiluted bodily fluid is hugely beneficial. In any label-free electrochemical assay, however, this is exceedingly demanding, and there exists, to the best of our knowledge, no prior report of the label free electroanalysis of any autoantibody in blood. On the back of the selectivity of our sensors, as depicted in FIG. 3, α-synuclein antibody levels were screened in the blood sera acquired from PD patients. In the first instance, the objective was to cleanly differentiate control patient samples from PD patient samples, with sensor response was quantified as (R_{CT}−R_{CT0})/R_{CT0}. As shown in FIG. 5, mean autoantibody levels were observed to be some 7 fold higher compared to controls (50% higher even in the early stage). A ROC curve analysis was carried out to further determine the reliability of these results. The area under the ROC curve for the autoimmune reactivity determined by EIS in PD patients (H&Y Stages 1-2.5) compared to controls were 0.948 (95% confidence interval of 0.89 to 1.00).

Subsequent to these analyses, assays were run across 30 patient and 14 control samples, with interfacial impedance responses cross referenced to the Hoehn and Yahr staging for PD (Zhao et al, Movement Disorders, 2010, 25, 710-716 and Hoehn & Yahr, Neurology, 1967, 17, 427-&). The ability of these assays to map out progression is striking (FIG. 6); notable also is the plateau in autoantibody levels in mid-term patients prior to a decrease at late disease stages (Gruden et al). These measurements are not only consistent with the previous studies (Gruden et at and Yanamandra et al, Plos One, 2011, 6), but they make a significant step forward providing quantitative values of autoimmune responses. Currently the compatibility of results produced in different laboratories represents a serious problem as most assays are semi-quantitative or qualitative (“yes” or “no” responses). Here we present direct quantitative approach, which can be easily reproduced in clinical set up and implemented for high-throughput screening.

### CONCLUSIONS

With a growing elderly population, Parkinson's disease has become increasingly prevalent. Motor and cognitive dysfunction associated with this state can have a profound influence on the general health and quality of life of those unfortunate enough to be impacted (including their families). There is, additionally, a very large, and rapidly growing, social and healthcare cost. In the majority of PD cases, 60-80% of dopaminergic neurons (brain cells) may be dead by the time clinical symptoms become obvious. There is, then, very considerable value in establishing reliable diagnostic tests that can feed directly into the establishment of early treatments and care packages. The fundamental aim of this work was to demonstrate the construction of a comparatively simple electrochemical assay for disease specific autoantibodies. The PEGylated synuclein interfaces utilised are demonstrably capable of supporting such assays with a clarity that we believe to be unprecedented. They, furthermore, do this within a format that can be hand-held and point of care in scale (potentially used in a clinic or GP's surgery and issuing results within seconds). Such a test, we believe would both enable early screening and powerfully underpin more aggressive early stage treatment. We believe the data presented to constitute convincing demonstration that α-synuclein antibodies are diagnostically important and that PD disease status can be both reliably recognised and progression mapped by assays of this type.

### Microelectrode Array

A typical microelectrode array comprises 6×100 micron gold working electrodes with a shared gold counter electrode, for example as fabricated by Triteq Ltd, UK. The electrodes are chemically modified, after chemical and electrochemical cleaning, by drop coating with appropriate reagents in the generation of a non fouling interface. They are then receptor modified (here with synuclein) and then washed.

Sample solutions (˜10 microlitres) are either dropped onto each sensory electrode or across the entire array (˜100 microlitres) or else added through an enclosing microfluidic system. Assays are then run and analysed as previously noted.

1.-16. (canceled)

17. A method for detection of autoantibodies, comprising detecting autoantibodies in a sample from an individual by label free electrochemical impedance spectroscopy.

18. A method for diagnosis or monitoring of Parkinson's disease, comprising detecting α-synuclein autoantibodies in a sample from an individual by electrochemical impedance spectroscopy.

19. The method according to claim 18, wherein the method comprises contacting (i) an electrode having α-synuclein or an antibody binding fragment thereof attached to a surface thereof, with (ii) the sample; and detecting an electrical signal associated with binding of α-synuclein antibody to the α-synuclein or antibody fragment binding fragment thereof.

20. The method according to claim 19, wherein the method further comprises adding a redox probe to the sample; and detecting a second electrical signal by Faradaic electrochemical impedance spectroscopy.

21. The method according to claim 18, wherein the sample comprises a biological fluid selected from blood, urine and cerebral spinal fluid.

22. The method according to claim 21, wherein the sample is a blood serum sample.

23. The method according to claim 21, wherein the method is conducted on an undiluted biological sample.

24. The method according to claim 18, wherein α-synuclein autoantibodies in the sample are detected as antibodies bound to an electrochemical impedance spectroscopy electrode, and wherein the method is conducted in an absence of any label for the bound antibodies.

25. The method according to claim 21, wherein the method comprises contacting an electrochemical impedance spectroscopy electrode with the sample to allow α-synuclein antibodies in the sample to bind to the electrode, rinsing the electrode to remove unbound species, and detecting an electrical signal in the presence of a redox probe.

26. The method according to claim 18, wherein the method comprises calculating a concentration of α-synuclein antibodies from an electrochemical impedance spectroscopy electrical signal.

27. The method according to claim 18, wherein an electrochemical impedance spectroscopy electrical signal detected in the sample from the individual, or an α-synuclein antibody concentration calculated therefrom, is compared to a second electrochemical impedance spectroscopy electrical signal that is obtained from a second sample from an individual not suffering from Parkinson's disease or to a second α-synuclein antibody concentration calculated therefrom.

28. The method according to claim 18, wherein the method is conducted on samples taken from the same individual over a period of time in order to monitor progression of Parkinson's disease in the individual.

29. The method according to claim 19 which further comprises at least one of: (a) dissociating α-synuclein antibodies from the α-synuclein or antibody binding fragment thereof attached to the electrode, and (b) reusing the electrode in one or more further methods for detecting α-synuclein antibodies in an electrochemical impedance spectroscopy technique.

30. An electrode for use in electrochemical impedance spectroscopy, comprising:
(a) a substrate having a planar surface; and
(b) α-synuclein or an antibody binding fragment thereof disposed on the planar surface.

31. The electrode according to claim 30, wherein said substrate is a gold substrate.

32. The electrode according to claim 30, wherein said substrate is coated with polyethylene glycol thiol for binding to the α-synuclein or antibody binding fragment thereof.


SEQUENCE LISTING (1 sequence)

SEQ ID NO: 1 - protein, 140 aa, Homo sapiens
MDVFMKGLSKAKEGVVAAAEKTKQGVAEAAGKTKEGVLYVGSKTKEGVVHGVATVAEKTKEQVTNVGGAVVTGVTAVAQKTVEGAGSIAAATGFVKKDQLGKNEEGAPQEGILEDMPVDPDNEAYEMPSEEGYQDYEPEA